(19) United States
(12) Patent Application Publication
(10) Pub. No.: US 2017/0032394 A1
(43) Pub. Date: Feb. 2, 2017

(54) System and method for automated testing of processor-based surveys

(71) Applicant: Survey Sampling International, LLC, Shelton, CT (US)

(72) Inventors: Christopher Stevens, Norwalk, CT (US); Kevin Franzman, Brookfield, CT (US); Vincent Sorrentino, Trumbull, CT (US); Zachary William Lysobey, Norwalk, CT (US); Ken Roe, Wallingford, CT (US); Edward David Zotter, Wilton, CT (US)

(73) Assignee: Survey Sampling International, LLC, Shelton, CT (US)

(21) Appl. No.: 14/814,508

(22) Filed: Jul. 30, 2015

(51) Int. Cl. G06Q 30/02

(52) U.S. Cl. CPC G06Q 30/0203

(57) ABSTRACT

In one embodiment, a testing server-implemented method for automated testing of a processor-based survey. The method includes: (a) the testing server receiving from a survey tester, via a testing user interface, a uniform resource locator (URL) of a survey residing on a survey hosting server, the survey hosting server having a processor adapted to administer, via a survey-taking interface, the survey to obtain survey data from survey-taking users; (b) the testing server traversing at least a portion of the survey; (c) the testing server analyzing the survey to generate one or more test results; and (d) the testing server providing the one or more test results to the survey tester via the testing user interface. The traversing includes: (b1) the testing server receiving survey content from the survey hosting server; and (b2) the testing server providing test data to the survey hosting server to simulate survey-taking-user-provided survey data. The one or more test results are based on information obtained by traversing the at least a portion of the survey in step (b).

### CROSS-REFERENCE TO RELATED APPLICATION

This application claims priority to co-pending U.S. Provisional Patent Application Ser. No. 62/030,703, filed Jul. 30, 2014, the disclosure of which is incorporated herein by reference in its entirety.

### FIELD OF THE DISCLOSURE

The present disclosure relates generally to surveys, and, in particular, to processor-based surveys that seek to obtain information from multiple respondents via a user interface.

### BACKGROUND

Surveys are data collection tools used to gather responses from individuals by asking them a series of questions. The set of questions asked within a survey can vary greatly from survey to survey, and can even vary from session to session within the same survey.

Processor-based surveys execute on a computer, mobile phone, or other interactive device and include various types of surveys and environments, including, e.g., a survey provided by a survey hosting server and taken by a user at home over the Internet, a survey administered to a user locally at a public kiosk, and a survey administered by telephone.

Numerous survey programming packages are used to create surveys that are processor-based. Surveys are programmed either through a graphical user interface (Qualtrics or Survey Monkey) or through a more traditional scripting or programming language (IBM Dimensions or Confirmit). There is great flexibility in what can be done in a survey; each survey has unique questions, skip logic, randomization, and other unique properties. This flexibility allows researchers to design any survey they can dream up, but results in a great deal of complexity and room for error when implementing surveys. With complexity comes the opportunity to make mistakes and create problems that can interfere with the survey taker's user experience or the accuracy or usefulness of the data collected—ranging from simple spelling mistakes to complex logic issues.

Conducting survey research can be a complex exercise that involves many different parties. In many cases, there is specialization of roles and responsibilities: there may be parties involved in executing the research who do not have intimate knowledge of the survey script logic and content. Researchers define the questionnaire, a survey programmer implements it, a sample supplier provides the respondents to take the survey, etc.

### SUMMARY

Embodiments of the present disclosure aim to test surveys quickly and thoroughly by providing an automated testing process for detecting problems in a survey that could affect the survey taker's user experience or the data collected.

In one embodiment, the present invention provides a testing server-implemented method for automated testing of a processor-based survey. The method includes: (a) the testing server receiving from a survey tester, via a testing user interface, a uniform resource locator (URL) of a survey residing on a survey hosting server, the survey hosting server having a processor adapted to administer, via a survey-taking interface, the survey to obtain survey data from survey-taking users; (b) the testing server traversing at least a portion of the survey; (c) the testing server analyzing the survey to generate one or more test results; and (d) the testing server providing the one or more test results to the survey tester via the testing user interface. The traversing includes: (b1) the testing server receiving survey content from the survey hosting server; and (b2) the testing server providing test data to the survey hosting server to simulate survey-taking-user-provided survey data. The one or more test results are based on information obtained by traversing the at least a portion of the survey in step (b).

In another embodiment, the present invention provides a testing server adapted to perform a method for automated testing of a processor-based survey. The testing server is adapted to: (a) receive from a survey tester, via a testing user interface, a uniform resource locator (URL) of a survey residing on a survey hosting server, the survey hosting server having a processor adapted to administer, via a survey-taking interface, the survey to obtain survey data from survey-taking users; (b) traverse at least a portion of the survey; (c) analyze the survey to generate one or more test results; and (d) provide the one or more test results to the survey tester via the testing user interface. The traversing includes: (b1) the testing server receiving survey content from the survey hosting server; and (b2) the testing server providing test data to the survey hosting server to simulate survey-taking-user-provided survey data. The one or more test results are based on information obtained by traversing the at least a portion of the survey in step (b).

### BRIEF DESCRIPTION OF THE DRAWINGS

FIG. 1 shows a system diagram of an exemplary automated survey testing tool, in one embodiment of the disclosure;

FIG. 2 shows a process flow diagram of an exemplary algorithm for performing automated survey testing, in one embodiment of the disclosure;

FIG. 3 shows a screen view of a survey input interface, in one embodiment of the disclosure;

FIG. 4 shows a screen view of an analysis engine progress interface, in one embodiment of the disclosure; and

FIGS. 5a and 5b collectively show a screen view of a results output interface, in one embodiment of the disclosure.

### DETAILED DESCRIPTION

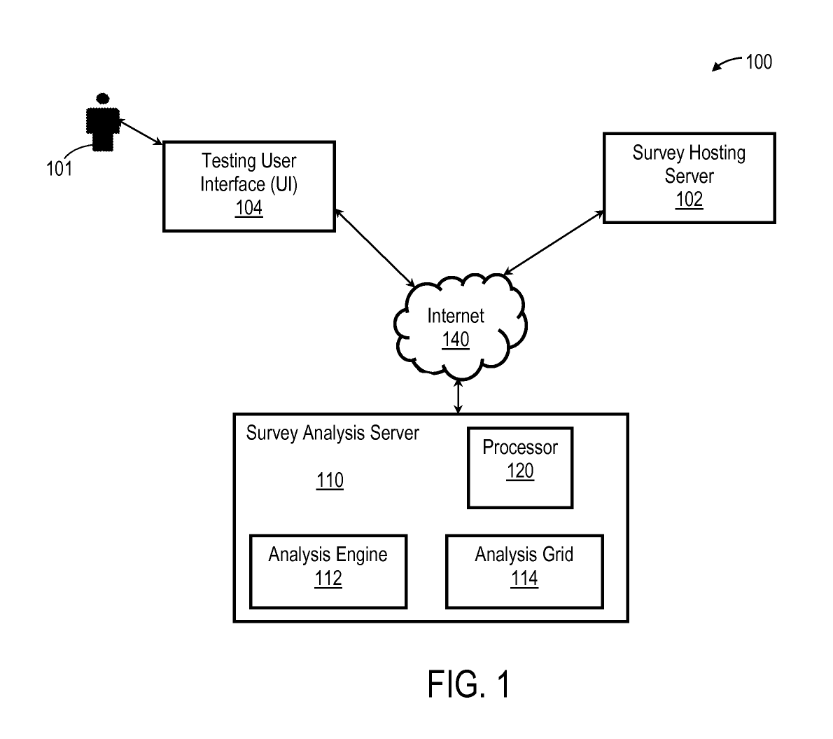

FIG. 1 shows an exemplary system 100 for automated testing of processor-based surveys, consistent with one embodiment of the disclosure. As shown, system 100 includes a survey analysis server 110 having an analysis engine 112, an analysis grid 114, and a processor 120.

Server 110 is coupled to a survey hosting server 102 and a testing user interface (UI) 104, e.g., directly, via a local-area network (LAN), or via the Internet 140. Processor 120 is adapted to execute program code, as described in further detail below, to perform the functionality of analysis engine 112 and analysis grid 114 described herein. One or more survey testers 101 access server 110 via the Internet 140, e.g., via one or more interfaces such as testing user interface 104. Testing UI 104 is used by survey testers 101 to push surveys to analysis server 110 for testing, as well as to receive from analysis server 110 both intermediate results during testing and final results once testing is complete. Analysis engine 112 coordinates the testing effort using one or more worker threads or processes in analysis grid 114, performs high-level page analysis, tracks and provides access to shared state across the worker threads in analysis grid 114 (such as outcomes to a question when it is answered in a certain way), and stores and returns test results to testing UI 104. Multiple instances of analysis engine 112 can run in parallel for scalability. Analysis grid 114 interacts with survey hosting server 102 by requesting pages, submitting forms, and returning results. Analysis grid 114 performs low-level analysis and interacts with the survey forms as a user would and further interacts with the forms programmatically by injecting data into pages.

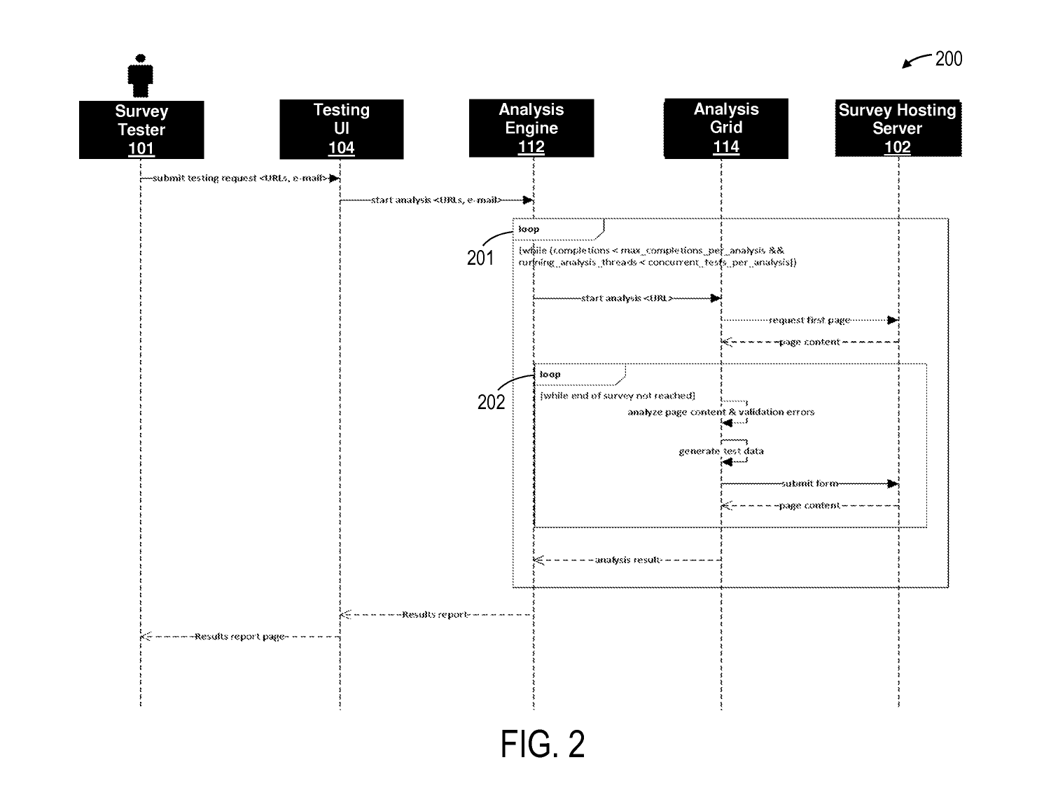

FIG. 2 shows an exemplary process flow 200 for survey analysis server 110 of FIG. 1 to perform automated survey testing, in one embodiment of the disclosure.

As shown, process 200 begins with a survey tester 101 submitting a testing request to testing UI 104. The request includes one or more URLs corresponding to one or more instances of a survey provided by survey hosting server 102 that survey tester 101 wishes to test, as well as an email address for survey tester 101, so that test results can be provided by email. Testing UI 104 provides a start instruction to analysis engine 112 including the URL(s) and email address provided by survey tester 101.

In an outer process loop 201, an algorithm implemented by analysis engine 112 and analysis grid 114 and executed by processor 120 repeats for a predetermined number of completions (max_completions_per_analysis) for each analysis of a survey at a specified URL. A multi-threaded process is performed, having a number of concurrent instances (running_analysis_threads) up to a predetermined maximum number of concurrent instances (concurrent_tests_per_analysis). Analysis engine 112 provides an instruction to analysis grid 114 to begin analysis of a URL, and analysis grid 114 requests the first page of the survey located at the URL from survey hosting server 102. Survey hosting server 102 provides subsequent survey content associated with the URL to analysis grid 114, and testing of the survey is performed in an inner process loop 202.

In inner process loop 202, until the end of the survey is reached, analysis grid 114 analyzes the content of each survey page and any validation errors received, generates and provides to survey hosting server 102 simulated test data via form submission (e.g., html) and receives subsequent page content from survey hosting server 102. Analysis grid 114 provides analysis results to analysis engine 112.

Once testing is complete, analysis engine 112 provides a results report to testing UI 104, which survey tester 101 views, e.g., in the form of a results report page.

It should be understood that process flow 200 may include other steps not specifically shown. For instance, it is desirable that the analysis engine be aware of the question-level outcomes so that information can be shared across other testing threads within analysis engine 112 and on analysis grid 114. This employs a callback after each question is answered to indicate what occurred on submission after answering a question in a certain way.

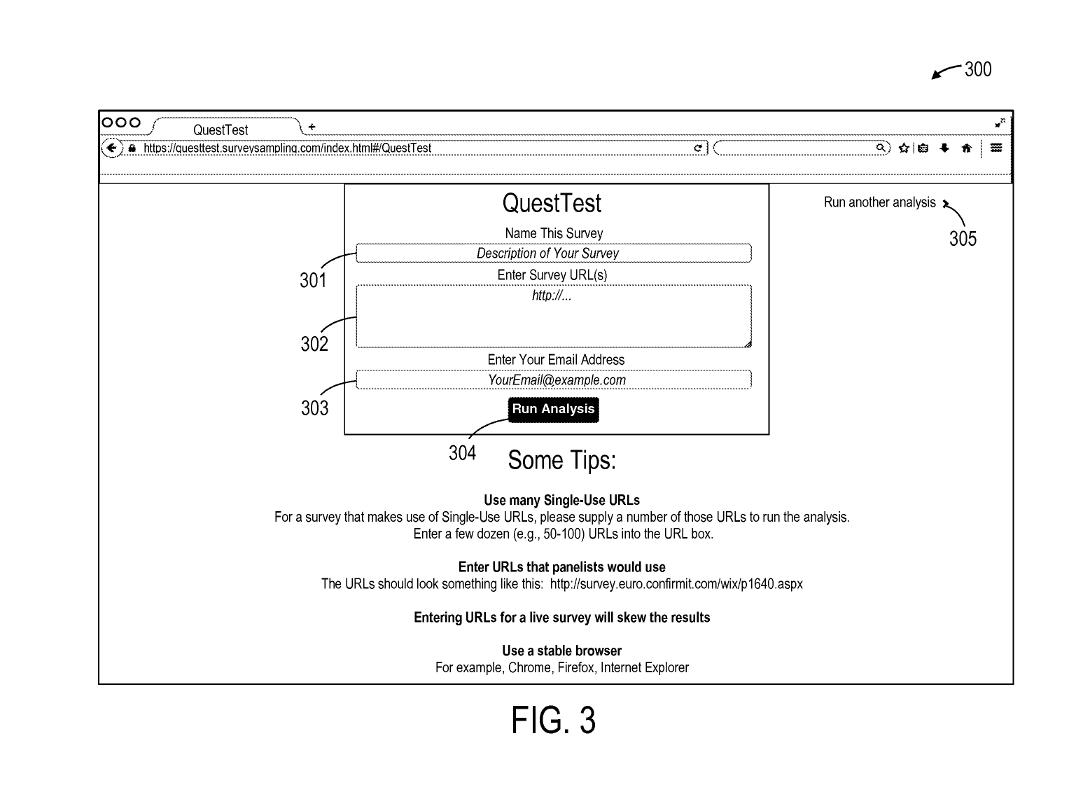

Additional details of the foregoing steps of process 200, in one exemplary embodiment, will now be described with reference to FIGS. 3 through 5b, which graphically illustrate certain screen views of an exemplary testing US 104. Although a survey tester 101 will typically be presented with the “screens” (or “screen views”) of FIGS. 3 through 5b in the sequence in which those views are presented herein, it should be understood that other sequences are possible, and that some views will be added, omitted, rearranged, or modified, in certain embodiments. It should also be understood that additional or alternative text and/or graphic content may be employed to achieve similar, alternative, or additional functionality, in embodiments of the disclosure.

FIG. 3 shows an exemplary survey input interface screen 300. Screen 300 provides the survey tester 101 with an interface for supplying information that initiates the survey testing process. After providing input to fields for the name 301 of the survey, the URL(s) 302 of the survey, and an email address 303 for the survey tester 101, the survey tester 101 selects a “Run Analysis” button 304 to begin the testing process. As will be described in further detail below, survey analysis server 110 presents a series of additional interface screens to survey tester 101, e.g., the designer of the survey. A “Run analysis” button 305 is provided to cancel and restart the process for one or more new URLs. Additional user tips and instructions are provided at the bottom of screen 300. Survey tester 101 provides either a single URL in field 302, or multiple URLs in the event the survey employs single-use URLs (i.e., the same URL cannot be used more than once to take a survey). For example, the user might enter 50 to 100 different URLs in field 302 for a single survey that employs single-use URLs.

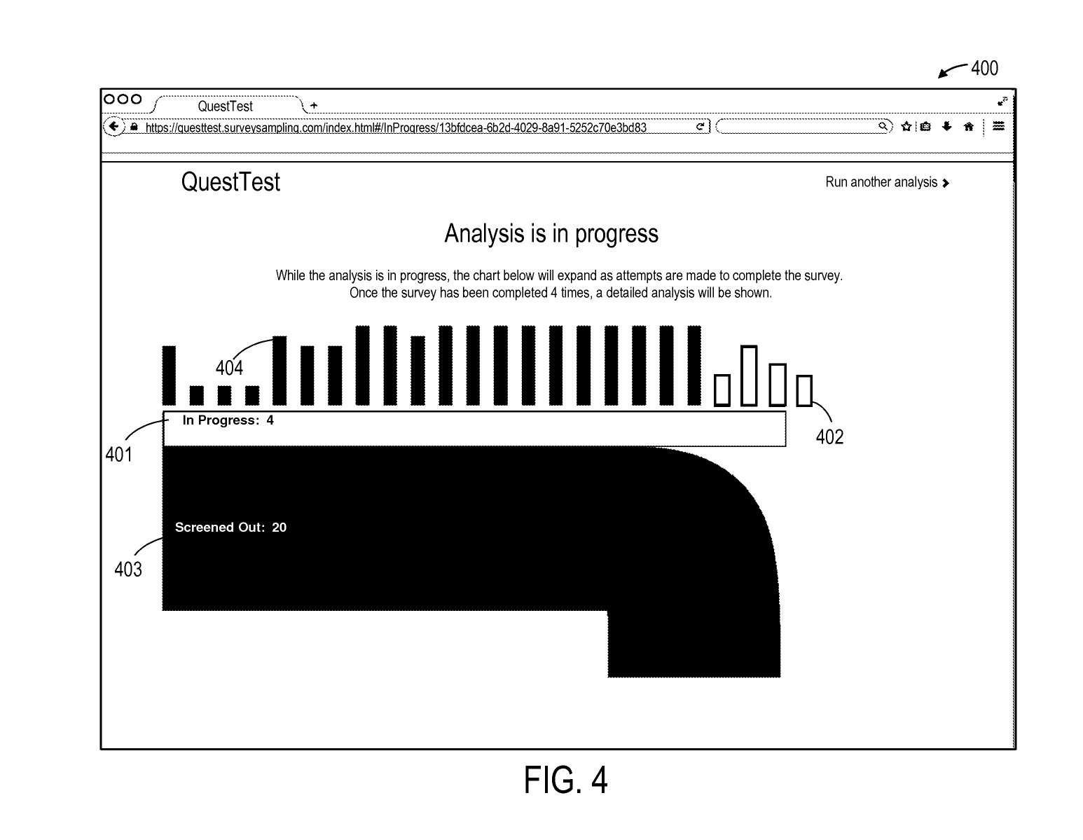

As shown in FIG. 4, once the analysis has begun, survey tester 101 is shown the progress of testing results via an interface such as exemplary analysis engine progress interface 400. The number of instances of survey tests in progress is shown both numerically in field 401 and graphically via bars 402. The number of “screened out” survey instances is shown both numerically in field 403 and graphically via bars 404. A “screened out” survey instance is one that cannot count as a fully-completed survey, e.g., because the user did not provide sufficient or specific enough information, was outside a target group for the survey, provided obviously false information, or the like.

During testing, the processes implemented by analysis grid 114 work to traverse the survey, just as a user would. Analysis grid 114 requests a page, analyzes the page to determine what question type is present, answers questions using simulated data, submits the page to survey hosting server 102, handles validation errors and resubmits if needed, and repeats until an end point of the survey has been reached. By employing a multi-threaded process, analysis grid 114 can simulate multiple human survey-takers running through the survey simultaneously, allowing many paths to be followed at the same time, which can improve test coverage and/or speed up the testing process. Simulated data may be provided, e.g., by a data store (not shown) of containing historical survey data, or by a dictionary, a database, or the like.

Analysis grid 114 may employ one or more different strategies for finding paths through the survey. For example, with repeated traversals, analysis grid 114 acquires knowledge of which answers resulted in being allowed to continue, and can follow “known good” paths to speed up testing. Alternatively or additionally, analysis grid 114 can randomly choose a path without relying on prior knowledge from other traversals, which may be desirable to obtain more thorough coverage but takes more time to execute. A combination of shared knowledge from prior traversals and randomness can be used to strike a good balance between coverage and testing time.

As each page is requested and returned by survey hosting server 102, and, as survey responses are collected by survey hosting server 102 from the simulated data being provided by analysis grid 114, analysis grid 114 analyzes the pages returned by survey hosting server 102. This analysis is twofold. First, analysis grid 114 employs the returned pages to determine how to answer questions and proceed through the survey. Second, analysis grid 114 employs the returned pages to learn about the survey logic, content, and technical requirements. This analysis process is performed by inspecting the page content returned from survey hosting server 102 and may include one or more of presence checking and semantic, contextual analysis, and other measures. Items being inspected may include, e.g., one or more of the following:
Questions: Number, type, response type, response options, content.
Words/sentences: Such as “first name”, profanities, spelling or grammar mistakes.
Images: Presence, size, content.
Objects: Required plugins or other non-HTML content.
Code: HTML, Javascript, or other code patterns or snippets.
Cookies: Any first or third party cookies dropped. Includes non-cookie client persistent storage.
Controls: Presence of human-verification measures (e.g., captcha), drag-and-drop questions, and other types of non-standard input.

In addition to inspecting individual pages and questions, feedback from the full traversal and the set of traversals can is analyzed in the aggregate, e.g., by analysis engine 112. Items being inspected may include, e.g., one or more of the following:
Performance: Length of time for pages to load
Frequencies: Total number of questions, images, words, pages, etc.
Dispositions: Number of instances resulting in a “complete” status vs. a “screenout” status or other status. Number of questions, pages, or time elapsed before reaching certain statuses.
Time: Amount of time survey is expected to take a user
Questions or Time before Terminate: Amount of effort users invest in the survey prior to screening out

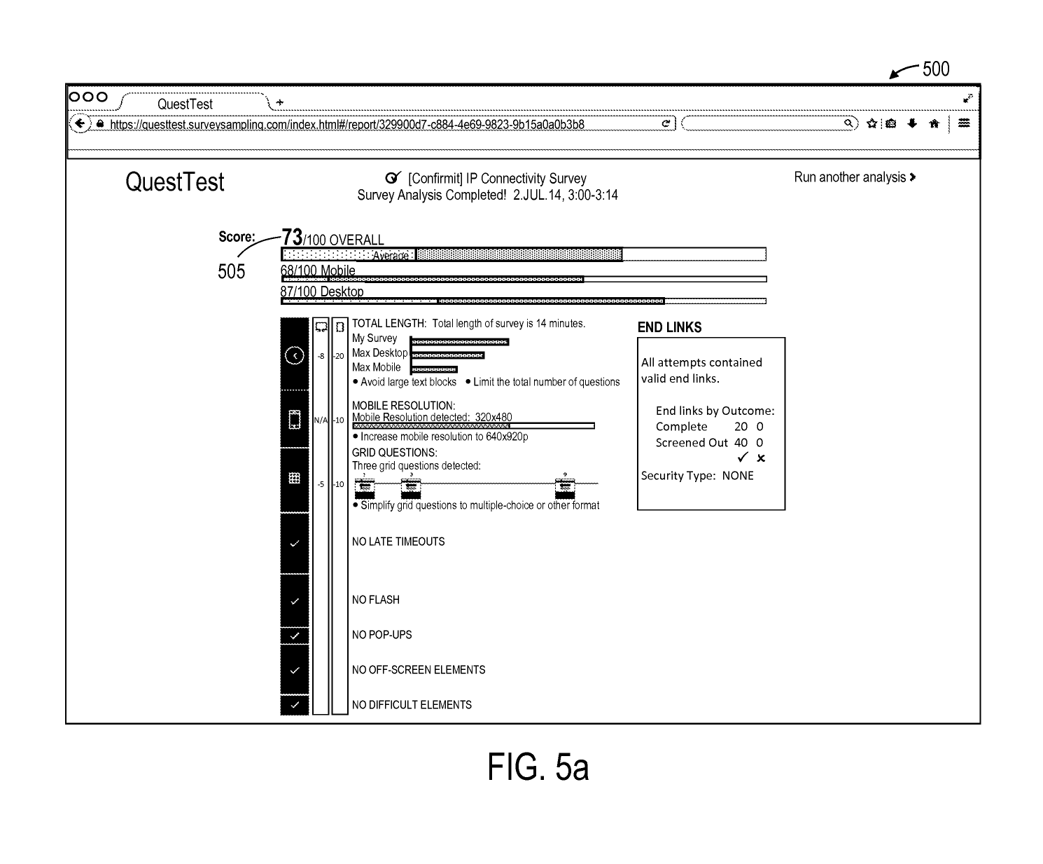

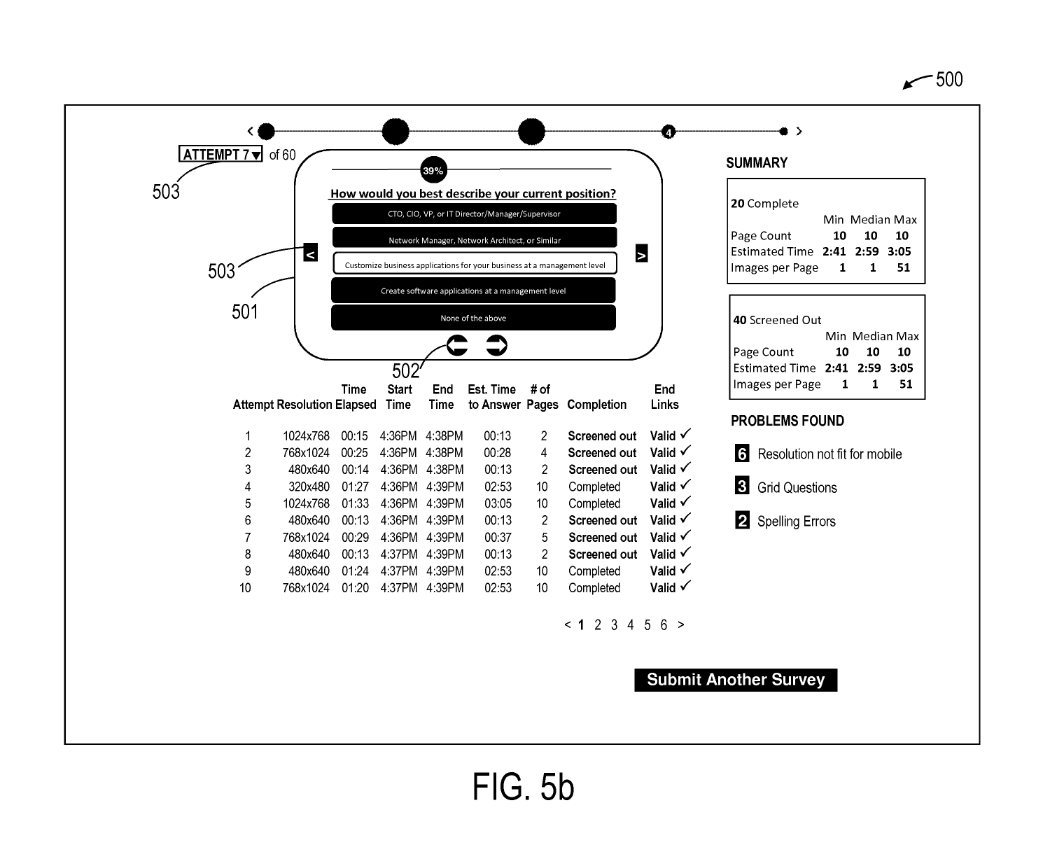

FIGS. 5a and 5b collectively show an exemplary results output interface 500 that reports results to survey tester 101, in one embodiment of the disclosure. The fields and features shown in interface 500 are not comprehensive and will vary based on what is or is not detected in the survey. In region 501, captured survey content from the test runs in the form of screenshots and/or video are provided to survey tester 101, allowing him or her to quickly flip through the survey to check content, using navigation controls 502 for survey questions and navigation controls 503 for survey instances. The screenshots are taken at multiple resolutions, with masks displayed to highlight cases where the content is cut off due to the resolution of the device. Testing at multiple resolutions also allows analysis engine 112 to determine if the survey can adapt dynamically to different screen sizes and device capabilities (responsive design).

The items detected by analysis engine 112 and analysis grid 114 during analysis are presented to survey tester 101, showing presence or absence of specific attributes, statistics about the survey, and screenshots of the survey. Issues detected in the survey include contextual information indicating where the issue was detected (on what test traversal and what page). Where possible, a link is provided so the survey tester can jump to the screenshot of the page that exhibited the issue.

In addition to the raw attributes and statistics, the system presents a score 505 (or ranking, or other measure or metric) that is calculated based, e.g., on the length, object counts, and other attributes detected while analyzing the survey. The score indicates overall expected user experience in the survey and is further broken down by desktop/laptop and mobile scores. This is very useful in determining whether a survey is mobile compatible and should or should not receive mobile respondents. Scoring is performed once the traversals are all complete. Scoring may be based on presence, absence, count, or frequency of attributes, including length in pages, questions, or time. Performance attributes can all feed into the score.

The specific formula, attributes, and/or design of the application may vary for different implementations, and the following list of attributes is merely exemplary:
Blacklisted Words
Flash/Objects
Pop-ups
Frames/Framesets
Document Width
Off-screen page elements (multiple resolutions)
Cookies and other client side persistence
Language
Question Types
Response Types
Image Counts
Page Counts
End Link Presence & Correctness
Question Difficulty
Estimated time to complete
Page Load time
Multiple resolutions & User-agents
Screenshots
Outcomes

In the embodiment shown in FIGS. 5a and 5b, scores are calculated using a base score of 100. Every survey starts with a score of 100 for both desktop and mobile, and these scores are blended to arrive at an overall score. Points are deducted when elements or patterns are detected. Since scoring stops at zero, a survey cannot earn a negative score. Deduction amounts may vary independently for mobile and desktop/laptop. The following table provides exemplary deduction amounts for negative survey elements or patterns, in one embodiment of the disclosure:

| Element/Pattern | Desktop Value | Mobile Value |
|---|---|---|
| Survey utilizes Flash | −5 | −100 |
| Survey has popups | −5 | −50 |
| Survey has Frames | −2 | −5 |
| Survey has off-screen page elements | −5 | −5 |
| One or more pages have 10+ images | −1 | −5 |
| Survey is too difficult | −1 per 30 s | −1 per 30 s |
| | over 10 m | over 6 m |
| Survey has grid questions | −2 per | −5 per |
| Survey has blacklisted words | −50 per | −50 per |
| Survey has late screen-outs | −100 | −100 |

Some metrics may vary based on time or frequency. For example, the “too difficult” metric would deduct one point for each 30 seconds over 10 minutes in estimated survey length for desktops. Estimated survey length is determined based on how long the system estimates a user will take to traverse the survey and may be derived from the number of questions in the survey, page load time, types of questions, and type and density of content on each page, such as the amount of text and other non-question time-consuming elements in the survey that a survey taker would need to process.

### Alternative Embodiments

It should be understood that appropriate hardware, software, or a combination of both hardware and software is provided to effect the processing described above, in the various embodiments of the disclosure. It should further be recognized that a particular embodiment might support one or more of the modes of operation described herein, but not necessarily all of these modes of operation.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

It should be understood that various changes in the details, materials, and arrangements of the parts which have been described and illustrated in order to explain the nature of embodiments of the disclosure may be made by those skilled in the art without departing from the scope of the disclosure. For example, it should be understood that the inventive concepts of embodiments of the disclosure may be applied not only in systems and methods for automated survey testing, but also in other related applications for which embodiments of the disclosure may have utility, such as the automated testing of other interactive systems, user interfaces, product and software interfaces, and the like.

Embodiments of the present disclosure can take the form of methods and apparatuses for practicing those methods. Such embodiments can also take the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the disclosure. Embodiments of the disclosure can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the disclosure. When implemented on a general-purpose processor, the program code segments combine with the processor to provide a unique device that operates analogously to specific logic circuits.

It will be appreciated by those skilled in the art that although the functional components of the exemplary embodiments of the system described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present disclosure. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the disclosure as described herein may be implemented in one or more computers residing on a network transaction server system, and input/output access to embodiments of the disclosure may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, Google Chrome™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the disclosure, in real-time and/or batch-type transactions. Likewise, a system consistent with the present disclosure may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, Google Chrome™, or Apple Safari™). Thus, embodiments of the present disclosure may be appropriately adapted to include such communication functionality and Internet browsing ability. Additionally, those skilled in the art will recognize that the various components of the server system of the present disclosure may be remote from one another, and may further include appropriate communications hardware/software and/or LAN/WAN hardware and/or software to accomplish the functionality herein described.

Each of the functional components of embodiments of the present disclosure may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the disclosure may be server-based and may reside on hardware supporting an operating system such as Microsoft Windows NT/2000™, Linux, or UNIX.

Components of a system consistent with embodiments of the disclosure may include mobile and non-mobile devices. Mobile devices that may be employed in embodiments of the present disclosure include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iOS operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the disclosure include 2.5G cellular network technologies such as GPRS and EDGE, as well as 3G technologies such as CDMA1×RTT and WCDMA2000, and 4G technologies. Although mobile devices may be used in embodiments of the disclosure, non-mobile communications devices are also contemplated by embodiments of the disclosure, including personal computers, Internet appliances, set-top boxes, landline telephones, etc. Clients may also include a PC that supports Apple Macintosh™, Microsoft Windows 95/98/NT/ME/CE/2000/XP/Vista/7™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to embodiments of the present disclosure. These personal computers may run the Unix, Microsoft Windows NT/2000™, Windows 95/98/NT/ME/CE/2000/XP/Vista/7™, or MacOS operating systems. The aforesaid functional components of a system according to the disclosure may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to embodiments of the present disclosure may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present disclosure to achieve additional functionality.

In one embodiment, source code may be written in an object-oriented programming language using relational databases. Such an embodiment may include the use of programming languages such as C++ and toolsets such as Microsoft's .Net™ framework. Other programming languages that may be used in constructing a system according to embodiments of the present disclosure include Java, HTML, Perl, UNIX shell scripting, assembly language, Fortran, Pascal, Visual Basic, and QuickBasic. Those skilled in the art will recognize that embodiments of the present disclosure may be implemented in hardware, software, or a combination of hardware and software.

Accordingly, the terms “computer” or “system,” as used herein, should be understood to mean a combination of hardware and software components including at least one machine having a processor with appropriate instructions for controlling the processor. The singular terms “computer” or “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like. The term “processor” should be construed to include multiple processors operating in concert with one another.

It should also be appreciated from the outset that one or more of the functional components may alternatively be constructed out of custom, dedicated electronic hardware and/or software, without departing from the present invention. Thus, embodiments of the invention are intended to cover all such alternatives, modifications, and equivalents as may be included within the spirit and broad scope of the disclosure.

It should be understood that various changes in the details, materials, and arrangements of the parts which have been described and illustrated in order to explain the nature of this disclosure may be made by those skilled in the art without departing from the scope of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

Although the disclosure has been set forth in terms of the exemplary embodiments described herein and illustrated in the attached drawings, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the disclosure be interpreted as encompassing all alterations, modifications, or alternative embodiments and applications as fall within the true spirit and scope of this disclosure.

It will be further understood that various changes in the details, materials, and arrangements of the parts which have been described and illustrated in order to explain the nature of this disclosure may be made by those skilled in the art without departing from the scope of the disclosure as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. A testing server-implemented method for automated testing of a processor-based survey, the method comprising:
(a) the testing server receiving from a survey tester, via a testing user interface, a uniform resource locator (URL) of a survey residing on a survey hosting server, the survey hosting server having a processor adapted to administer, via a survey-taking interface, the survey to obtain survey data from survey-taking users;
(b) the testing server traversing at least a portion of the survey, wherein the traversing includes:
(b1) the testing server receiving survey content from the survey hosting server; and
(b2) the testing server providing test data to the survey hosting server to simulate survey-taking-user-provided survey data;
(c) the testing server analyzing the survey to generate one or more test results, wherein the one or more test results are based on information obtained by traversing the at least a portion of the survey in step (b); and
(d) the testing server providing the one or more test results to the survey tester via the testing user interface.

2. The method of claim 1, wherein the method further comprises performing step (b) two or more times in parallel instances, so as to traverse two or more surveys concurrently.

3. The method of claim 1, wherein the method further comprises performing step (b) two or more times in series, so as to repeat traversal of the same survey.

4. The method of claim 1, wherein the method further comprises determining the test data for an instance of step (b) based, at least in part, on test results from a prior instance of step (b).

5. The method of claim 1, wherein the testing server and the survey hosting server are the same server.

6. The method of claim 1, wherein the method further comprises determining which test data resulted in being permitted to continue taking the survey and to store at least one set of test data reflecting a successful path through the survey to use for a subsequent traversal.

7. The method of claim 1, wherein the method further comprises choosing test data that traverses a random path through the survey.

8. The method of claim 1, wherein the information obtained by traversing the at least a portion of the survey in step (b) includes information about one or more of the survey's content, logic, difficulty, and technical requirements.

9. The method of claim 1, wherein step (c) includes performing at least one of presence checking, semantic analysis, and contextual analysis.

10. The method of claim 1, wherein the survey content includes at least one survey question, and step (c) includes analyzing the at least one survey question by at least one of: determining the number of questions in the survey, determining question type, determining response type, determining response options, and analyzing content of the at least one survey question.

11. The method of claim 1, wherein step (c) includes determining the presence of one or more names, profanities, blacklisted words, or spelling or grammar mistakes.

12. The method of claim 1, wherein step (c) includes determining one or more of the presence, size, and content of images in the survey.

13. The method of claim 1, wherein step (c) includes determining the presence of one or more of required objects, plugins, and non-HTML content.

14. The method of claim 1, wherein step (c) includes determining the presence of one or more of HTML, Javascript, and other code patterns or snippets.

15. The method of claim 1, wherein step (c) includes determining storage of a first or third party cookie or non-cookie client persistent storage.

16. The method of claim 1, wherein step (c) includes determining presence of one or more human-verification measures, drag-and-drop questions, and other non-standard input.

17. The method of claim 1, wherein step (c) includes determining a page-load time length.

18. The method of claim 1, wherein step (c) includes determining one or more of a total number of questions, a total number of images, a total number of words, and a total number of pages.

19. The method of claim 1, wherein step (c) includes determining a number of instances resulting in a “complete” status, a number of instances resulting in a “screenout” status or other status, and/or a number of questions, pages, and/or time elapsed before reaching certain statuses.

20. The method of claim 1, wherein step (c) includes determining an amount of time that the survey is expected to take a user.

21. The method of claim 1, wherein step (c) includes determining an amount of effort users invest in the survey prior to “screening out”

22. The method of claim 1, wherein step (c) includes determining one or more of: the presence of Adobe Flash objects, the presence of pop-up windows or tabs, the use of frames or framesets, the document width of the survey, the presence of off-screen page elements at multiple resolutions, the presence of a particular language, and end link presence and correctness.

23. A testing server adapted to perform a method for automated testing of a processor-based survey, the testing server adapted to:
(a) receive from a survey tester, via a testing user interface, a uniform resource locator (URL) of a survey residing on a survey hosting server, the survey hosting server having a processor adapted to administer, via a survey-taking interface, the survey to obtain survey data from survey-taking users;
(b) traverse at least a portion of the survey, wherein the traversing includes:
(b1) receiving survey content from the survey hosting server; and
(b2) providing test data to the survey hosting server to simulate survey-taking-user-provided survey data;
(c) analyze the survey to generate one or more test results, wherein the one or more test results are based on information obtained by traversing the at least a portion of the survey in step (b); and
(d) provide the one or more test results to the survey tester via the testing user interface.
